(19) United States
(12) Patent Application Publication
(10) Pub. No.: US 2006/0271503 A1
(43) Pub. Date: Nov. 30, 2006

(54) Methods and systems for interactive signal analysis

(76) Inventor: Per Kangru, Copenhagen (DK)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/127,630

(22) Filed: May 12, 2005

(51) Int. Cl. G06F 17/30; G06F 7/00

(52) U.S. Cl. 707/2

(57) ABSTRACT

Graphical user interfaces, methods and systems that enable the selection, grouping and analysis of data.

### BACKGROUND OF THE INVENTION

As the use of networks increases, especially in telecommunications, network system providers face conflicting demands from the customer, who demands increase network reliability and performance, and from the business environment, which is sensitive to the cost of operating and maintaining the higher level of service. In order to satisfy or balance those demands, network analysis systems have been developed to facilitate the planning, troubleshooting, installing, and maintaining present-day networks.

Many network analysis systems have a graphical user interface that displays data in the network grouped by data session or by independent network events. A number of these groups can be displayed along with characteristics of the data. The display enables the identification of errors. In present day network analysis systems, it is possible to select criteria for display of network data by a “drill-down” menu. However, there is a need for improved selection of criteria for displaying network data and characteristics. Therefore, there is a need for improved graphical user interfaces.

### SUMMARY OF THE INVENTION

In one instance, the graphical user interface of this invention includes a component capable of selecting criteria from a structured collection of data, the structured collection of data including criteria for selecting properties of acquired information, and, a portion (such as, in one embodiment, but not limited to, a list) of the acquired information, the portion displayed on a display device and satisfying criteria selected by use of the component.

In one embodiment, the acquired information includes signaling messages and the criteria include filters for analyzing the signaling messages.

In another instance, a computer readable medium has computer readable code embodied therein that causes a computer to implement the graphical user interface of this invention. In another embodiment, the computer readable code can also cause a computer to update the structured collection of data and update the component such that the updated component is capable of selecting criteria from the updated structured collection of data.

Methods and systems for implementing the present invention are also disclosed.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a graphical depiction of a user interface in a conventional network analysis system;

FIG. 2 is a graphical depiction of an embodiment of the user interface of this invention;

FIG. 3 is a graphical schematic representation of a flowchart of an embodiment of the method of this invention;

FIG. 4 is a graphical schematic representation of a flowchart of another embodiment of the method of this invention; and

FIG. 5 is a graphical schematic representation of a block diagram of an embodiment of the system of this invention.

### DETAILED DESCRIPTION OF THE INVENTION

Graphical user interfaces, methods and systems that enable the selection grouping and analysis of data are disclosed herein below.

In one instance, the graphical user interface of this invention includes a component capable of selecting criteria from a structured collection of data, the structured collection of data including criteria for selecting properties of acquired information, and, a portion (such as, in one embodiment, but not limited to, a list) of the acquired information, the portion displayed on a display device and satisfying criteria selected by use of the component.

In another instance, a computer readable medium has computer readable code embodied therein that causes a computer to implement the graphical user interface of this invention. In another embodiment, the computer readable code can also cause a computer to update the structured collection of data and update the component such that the updated component is capable of selecting criteria from the updated structured collection of data.

A “structured collection of data” as used herein includes, but is not limited to, lists, a structured arrangement containing of data, and other means for providing groupings of data.

“Component” as used herein refers to means for selecting options in graphical user interfaces (GUIs) such as, but not limited to, menus, pull down menus, drag and drop between dialog boxes, and other selecting means (see, for example, C. Petzold, Programming Windows, ISBN 1-57231-995-X, Ch. 9, Ch. 10, Ch. 11, pp. 357-566).

In one embodiment, the acquired information includes signaling messages and the criteria include filters for analyzing the signaling messages.

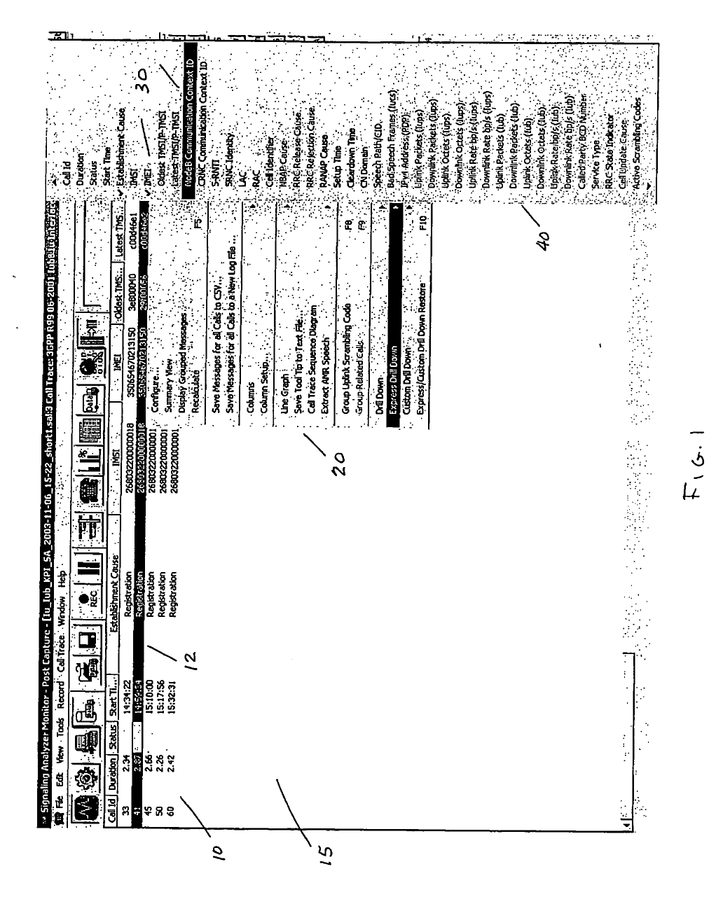

In order to elucidate the description of the user interface of this invention, a description of a user interface of a conventional signal (network) analysis system, wherein the acquired information includes signaling messages and the criteria include filters for analyzing the signaling messages, is presented below. A user interface of a conventional signal analysis system is shown in FIG. 1. Referring to FIG. 1, data 10 for a number of signaling messages (wireless telephone calls in the example shown) is displayed in a Call Trace window 15. The user can select one message 12 to analyze further. Upon selecting the message, the user is presented with a menu 20 from which, by selecting “express drill down,” the user can further select an attribute 30 that has a corresponding filter for analyzing the selected message 12 from a drop down menu 40. The user can then have access to the results obtained by applying the selected filter 30 to the selected message 12. (Drill down as used here in refers to a component that allows the user to obtain more data from a general or summarized report.) The selection is performed in two “windows” (20, 40, FIG. 1) and the user cannot see the selection in the Call Trace window 15.

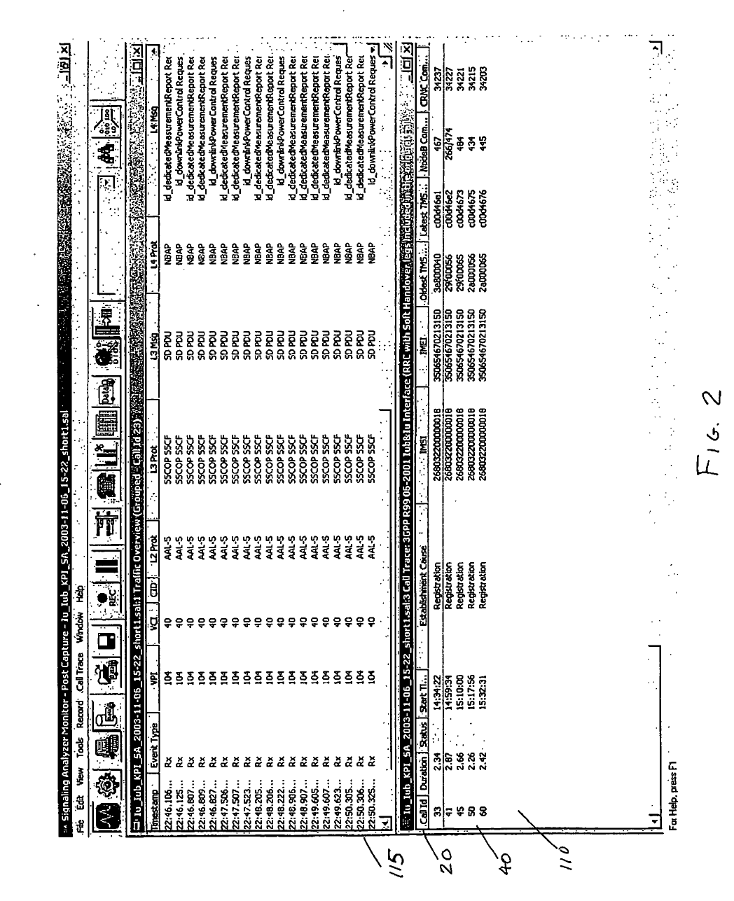

In an embodiment of the user interface of this invention, shown in FIG. 2, the user can select a number of attributes 30, which have corresponding filters, from a drop-down menu, such as the drop-down menu 40 in FIG. 1 (but, other components besides drop-down menus are also within the scope of his invention). In the embodiment shown in FIG. 1, a split screen 110, 115 is utilized. At the top of the lower screen 110, access to the filters is provided in by a menu bar 120. By selecting (such as by pressing or clicking on) an attribute, which has a corresponding filter, from the menu bar 120, a list of acquired information is displayed. For example, in the embodiment shown, selecting IMSI would result in displaying all IMSI in the acquired information (signaling messages). (IMSI lookup is the network inquiry that returns the home network of a mobile phone number.) The embodiment 100 of the user interface of this invention shown in FIG. 2 includes a drop-down menu (a component), such as the drop-down menu 40 in FIG. 1, and also displays a subset 140 (portion) of the acquired signaling messages. In one instance, the user can select call attributes from the drop-down menu and, by selecting those attributes, only calls that have that attribute are applied the corresponding filter. In another instance, the quantity of data items having a value for a selected attribute substantially equal to a predetermined value for a selected attribute (or a value displayed for a selected data item) or substantially within a predetermined range can be displayed.

The embodiment 100 of the user interface of this invention shown in FIG. 2 also includes an upper window 115 in which the acquired data is displayed.

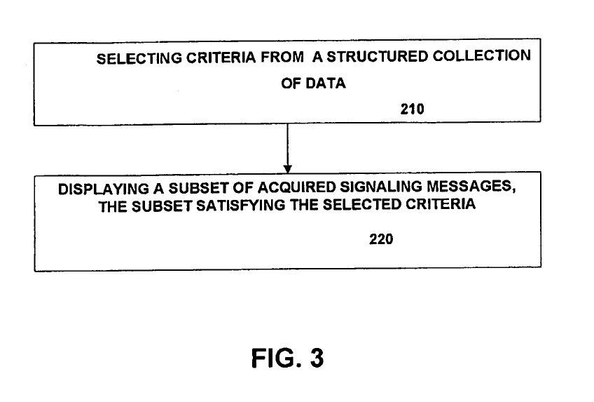

An embodiment of the method of this invention is shown in FIG. 3. Referring to FIG. 3, criteria are first selected from a structured collection of data (step 210, FIG. 3; in the embodiment in which the acquired information comprises signaling messages and structured collection of data includes filters for selecting properties of the acquired signaling messages, filters are selected from the structure collection or database of filters). Utilizing the selected criteria, a portion (subset) of the acquired information is displayed on a display device, where the portion displayed satisfies the selected criteria (step 220, FIG. 3). An exemplary embodiment of the result of the application of the method, although the invention is not limited to this embodiment, is shown in FIG. 2 where the selected criteria are filters and a subset of the signaling messages 140 are displayed along with the results obtained from applying the filters.

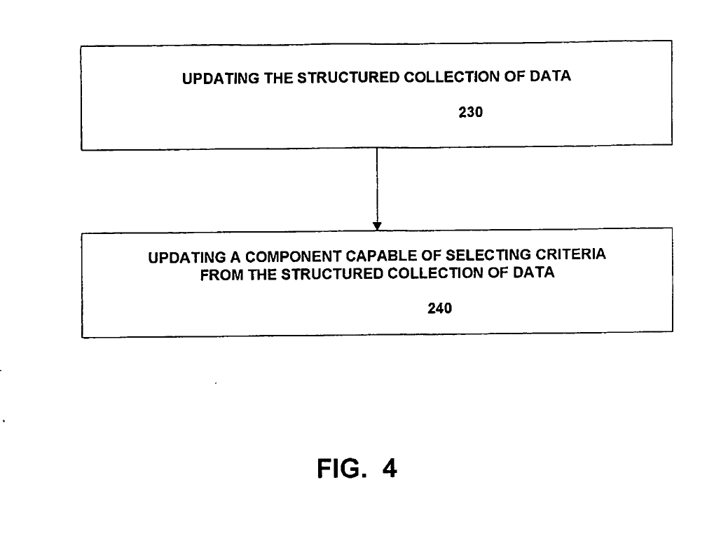

In a further embodiment of the method of this invention, shown in FIG. 4, the method allows updating the structured collection of data (step 230, FIG. 4). The structured collection of data may be updated, in one embodiment, but this invention is not limited only to this embodiment, by use of a component that allows user input, such as for example, dialog boxes, drag and drop between dialog boxes, and other input means (see, for example, C. Petzold, Programming Windows, ISBN 1-57231-995-X, Ch. 9, Ch. 10, Ch. 11, pp. 357-566).

Once the structured collection of data is updated (step 230, FIG. 4), the component capable of selecting criteria from the structured collection of data can be updated (step 240, FIG. 4), where the updated component can select criteria from the updated structured collection of data.

In still another embodiment of the method of this invention, the component capable of selecting criteria from the structured collection of data can be updated (step 240, FIG. 4), where the updated component can select criteria from the structured collection of data. In one instance, in the embodiment in which the acquired information comprises signaling messages and structured collection of data includes filters for selecting properties of the acquired signaling messages, the user can deselect filters by means of, for example, a checkbox next to the filter name in the component (for example, a drop-down menu) or by “right clicking” on the filter name and obtaining a control menu allowing deselecting of the filter.

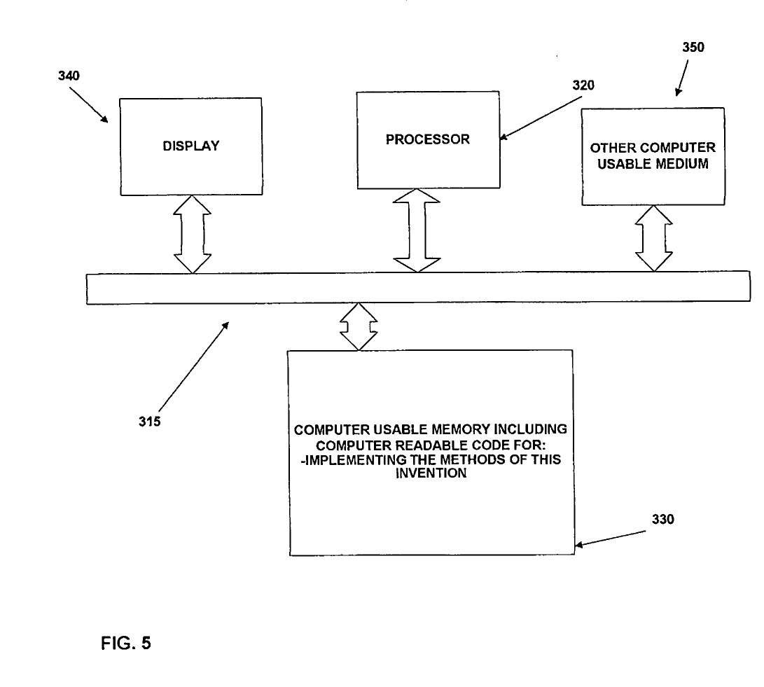

A schematic block diagram representation of an embodiment of the system of this invention is shown in FIG. 5. The embodiment of the system of this invention shown in FIG. 5 includes one or more processors 320, a display device 340, and a computer usable medium (memory) 330. The computer usable memory 330 as computer readable code embodied therein that is capable of causing the one or more processors 320 to provide a user interface for depiction in the display device 340, the user interface comprising a component capable of selecting criteria from a structured collection of data, where the structured collection of data comprises criteria for selecting properties of acquired signaling messages, and to display, upon user input, a subset of the acquired signaling messages, the subset satisfying the selected criteria. In one instance, but not a limitation of this invention, the computer readable code, which causes the one or more processors 320 to provide the user interface, is generated starting from a higher-level language utilizing the application program interface (API) of the operating system being used (for example, but not limited to, the Windows API).

In one embodiment, the computer readable code can also cause the one or more processors 320 to update the structured collection of data and, to update the component capable of selecting criteria from the structured collection of data, where the updated component is capable of selecting criteria from the updated structured collection of data.

In another embodiment, the computer readable code can also cause the one or more processors 320 to update the component capable of selecting criteria from the structured collection of data. For example, the present invention not being limited to only this example, in the embodiment in which the acquired information comprises signaling messages and structured collection of data includes filters for selecting properties of the acquired signaling messages, one or more of filters could be deselected from the component (for example, a drop-down menu). As stated above, the user can deselect filters by means of, for example, a checkbox next to the filter name in the component (for example, a drop-down menu) or by “right clicking” on the filter name and obtaining a control menu allowing deselecting of the filter or any other method provided by the API for selecting or deselecting a choice (criterion) in a component. After the component has been updated, if desired, the structured collection of data can be also updated.

The embodiment of the system of this invention shown in FIG. 5 also includes one or more other computer memories (computer usable media) 350, which in one instance can store the structured collection of data in a database. The display element 340, the one or more processors 320, the computer usable medium 330, and the other computer usable medium 350 are operatively connected by means of a connection component 315 (the connection component may be, for example, a computer bus, or a carrier wave).

It should be noted that the one or more computer usable media 330 and the one or more all her computer usable media 350 can be the same computer usable media. That is, the computer readable code and the structured collection of data may be stored in the same physical memory (computer usable medium).

The techniques described above may be implemented in one or more computer programs executing on a programmable computer including a processor, a storage medium readable by the processor (including, for example, volatile and non-volatile memory and/or storage elements), and, in some embodiments, also including at least one input device, and/or at least one output device. Program code may be applied to data entered using the input device (or user interface) to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, an object-oriented programming language, or a combination thereof. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes or other patterns, a RAM, a PROM, and EPROM, a FLASH-EPROM, any other memory chip or cartridge, a carrier wave, such as electromagnetic radiation or electrical signals, or any other medium from which a computer can read.

Although the invention has been described with respect to various embodiments, it should be realized this invention is also capable of a wide variety of further and other embodiments within the spirit and scope of the appended claims.

What is claimed is:

1. A user interface for depiction on a display device, the user interface comprising:
a component capable of selecting criteria from a structured collection of data, said
structured collection of data including criteria for selecting properties of acquired information; and,
a portion of the acquired information, said portion displayed on the display device, and said portion satisfying criteria selected by use of said component.

2. The user interface of claim 1 wherein the acquired information comprises signaling messages.

3. The user interface of claim 2 wherein said criteria comprises filters for analyzing the signaling messages.

4. A computing device and associated display device, the computing device being programmed to implement the user interface of claim 1.

5. A computer readable medium having computer executable code embodied therein, said computer executable code being capable of causing a computer to implement the user interface of claim 1.

6. The computer readable medium of claim 5 where in said computer executable code is also capable of causing the computer to:
update the structured collection of data; and,
update said component, where in said updated component is capable of selecting criteria from the updated structure collection of data.

7. The user interface of claim 1 further comprising means for deselecting criteria.

8. A method for displaying acquired signaling messages, the method comprising the steps of:
selecting criteria from a structured collection of data, the structured collection of data including criteria for selecting properties of acquired signaling messages; and,
displaying a subset of the acquired signaling messages, the subset satisfying the selected criteria.

9. The method of claim 8 further comprising the steps of:
updating the structured collection of data; and,
updating a component capable of selecting criteria from the structured collection of data.

10. The method of claim 8 further comprising the step of:
updating a component capable of selecting criteria from the structured collection of data

11. A system for analyzing and displaying acquired signaling messages, the system comprising:
at least one processor;
a display device;
at least one computer usable medium having computer readable code embodied there in, said computer readable code being capable of causing said at least one processor to:
provide a user interface for depiction in the display device, the user interface comprising a component capable of selecting criteria from a structured collection of data, the structured collection of data comprising criteria for selecting properties of acquired signaling messages,
display, upon user input, a subset of the acquired signaling messages, the subset satisfying the selected criteria.

12. The system of claim 11 further comprising:
at least one other computers usable medium comprising said structured collection of data.

13. The system of claim 11 wherein said computer readable code is also capable of causing said at least one processor to:
update the component capable of selecting criteria from the structured collection of data,

14. The system of claim 11 wherein said computer readable code is also capable of causing said at least one processor to:
update the structured collection of data; and,
update the component capable of selecting criteria from the structured collection of data.
